(19) United States
(12) Patent Application Publication
(10) Pub. No.: US 2009/0259722 A1
(43) Pub. Date: Oct. 15, 2009

(54) Method and System for Previewing of Forwarding File Attachments Received During a Chat Session

(75) Inventor: Girish Sundaram, Pune (IN)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/100,215

(22) Filed: Apr. 9, 2008

(51) Int. Cl. G06F 15/16

(52) U.S. Cl. 709/206

(57) ABSTRACT

A method and system for improving the functionality of real-time messaging (chat) applications and services. The method and system may use temporary storage directories to enhance user experience and provide new functionalities, such as instant previewing and forwarding of electronic files received via the chat application.

### BACKGROUND OF THE INVENTION

1. Field of the Invention

This invention relates to real-time messaging (chat) services and more particularly, to the storage and use of electronic files received from another user during a chat session.

2. Background

During chat sessions using conventional chat services like AOL Instant Messenger (AIM), MSN Messenger, Google Talk and IBM Sametime Connect, users can send electronic files to their chat partners using the messaging application's “Send File” feature (or some similarly named feature). The electronic file is then downloaded locally onto the receiving user's system once he accepts the file, either to a storage directory selected by the user when accepting the file (i.e., dynamic) or to a storage directory predefined by the user in the messaging application's preferences menu (i.e., static).

It is recognized that the electronic file can contain all forms of information in a digital format. For example, the electronic file can be comprised of text, images, video, music, and any other form of data and any combination thereof.

None of the existing chat utilities have the functionality of forwarding the received file, immediately upon receipt, to a third user of the chat service, without first downloading the file to the system explicitly (to the static or dynamic storage directory). After downloading the file explicitly, existing chat utilities further require the user to manually attach the saved file from the storage directory to a chat session and use the “Send File” feature. There is therefore no ability to simply forward the received file as soon as it is received.

Additionally, existing chat utilities do not provide the ability to immediately preview a file upon receipt, and first require the user to explicitly store the file in the static or dynamic storage directory. On many occasions however, the user may desire to preview the received file before determining whether the user wants to permanently save the file in the static or dynamic storage directory.

The problem with existing chat utilities therefore is that users are required to explicitly save a local copy of the received file to the static or dynamic storage directory before viewing it or forwarding it to another user.

### SUMMARY OF THE INVENTION

The invention provides a new method and system for previewing or forwarding electronic files received during a chat session. Upon receiving and accepting an electronic file from a first user via a real-time messaging application that is associated with a real-time messaging service, a second user's real-time messaging application automatically saves the electronic file in a predetermined temporary storage directory. This enables the second user to preview the electronic file without being first required to save the electronic file in a permanent storage directory and without having to know the location of the temporary storage directory or the filename of the electronic file. Additionally, the second user can use the real-time messaging application to forward the electronic file to a third user without being first required to save the electronic file in a permanent storage directory and without having to know the location of the temporary storage directory or the filename of the electronic file. If the second user does not save the electronic file before exiting the real-time messaging application, it can be deleted from the temporary directory. Alternatively, the file is not deleted from the temporary directory when the user exits the real-time messaging application but can be deleted during any automatic system routine that deletes the contents of the temporary directory.

Other functionalities and aspects of the invention may be presented in the embodiment of the invention, which is described herein.

### BRIEF DESCRIPTION OF THE DRAWINGS

The subject matter which is regarded as the invention is particularly pointed out and distinctly claimed in the claims(s) at the conclusion of the specification. The foregoing and other objects, features, and advantages of the invention are apparent from the following detailed description taken in conjunction with the accompanying drawings in which:

FIG. 1 illustrates a number of users who can communicate and transfer electronic files via a chat service on a network.

FIG. 2 illustrates a prior art implementation of file transfers.

FIG. 3 illustrates the added functionality implemented by an embodiment of the invention.

FIG. 4 shows an illustrative computer environment for managing the processes in accordance with the embodiment of the invention.

The detailed description explains embodiments of the invention, together with the advantages and features, by way of example with reference to the drawings, which are not necessarily drawn to scale.

### DETAILED DESCRIPTION OF THE INVENTION

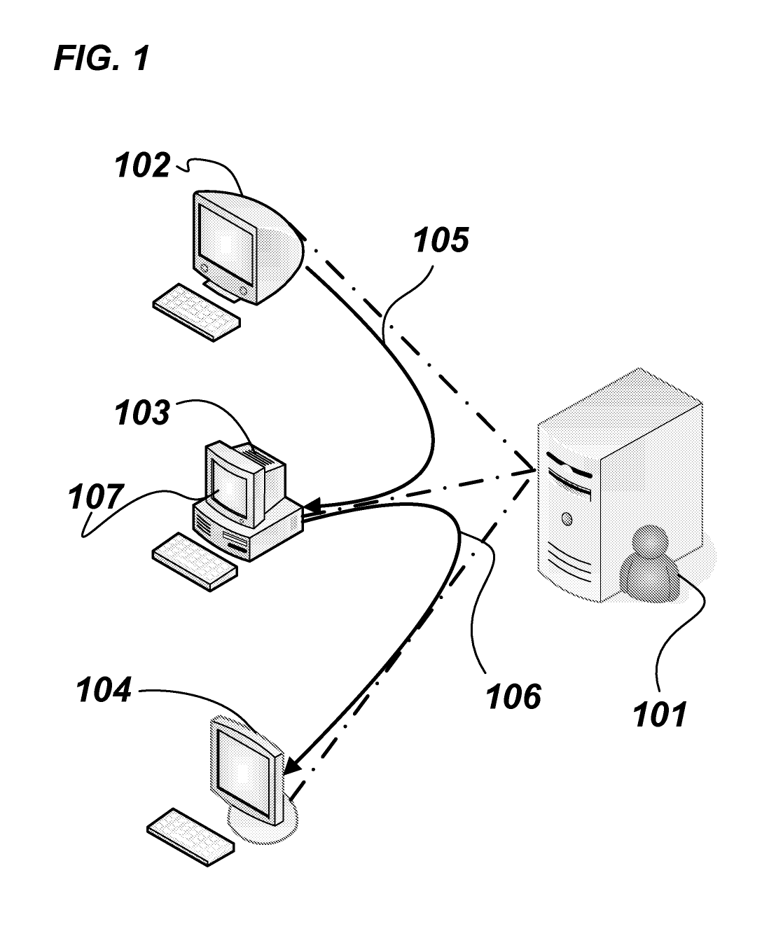

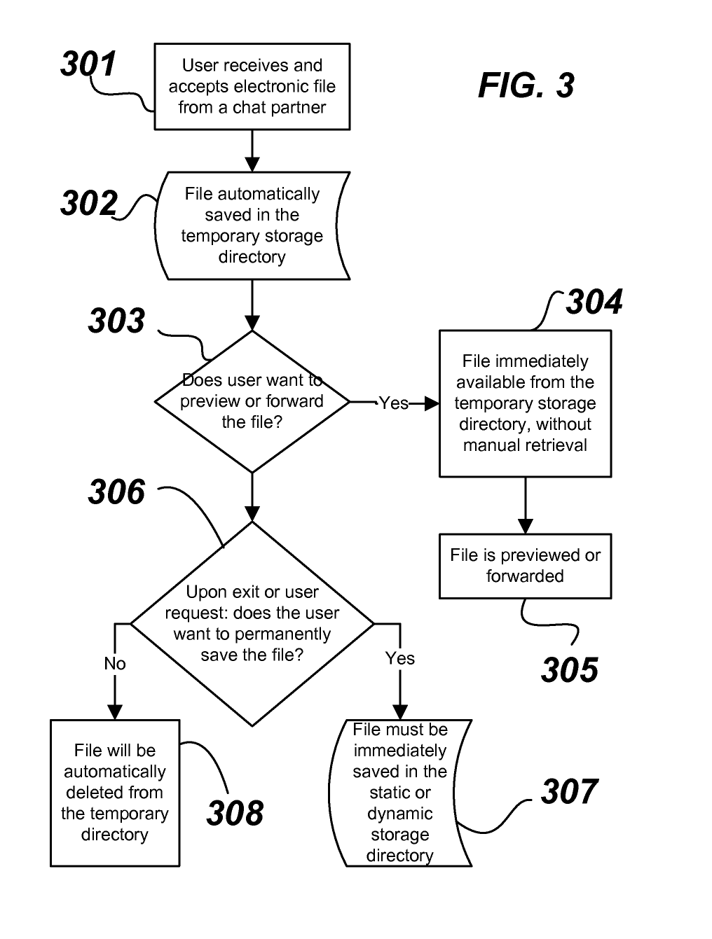

FIG. 1 illustrates an embodiment of the invention wherein a number of users who can communicate and transfer electronic files using a real-time messaging application (also known as a chat program or chat application or instant messaging application) associated with a real-time messaging service (also known as a chat service or instant messaging service) 104 provided over a network (such as the Internet). Many users 101, 102, 103 can be connected to the chat service and the users can communicate with more that one other user at the same time. When the first user 101 transmits via communication line 105 (which is established by the chat service) an electronic file to the second user 102 over the chat service 104, the second user 102 can be prompted whether the file should be accepted. Upon accepting the file, the second user may desire to immediately preview the file, to the extent possible, on a display 107 and may also, or alternatively, desire to immediately forward via communication line 106 (which is established by the chat service) the received file to a third user 103 over the chat service 104. The added functionality of the embodiment becomes apparent after viewing FIG. 1 in accordance with FIG. 3.

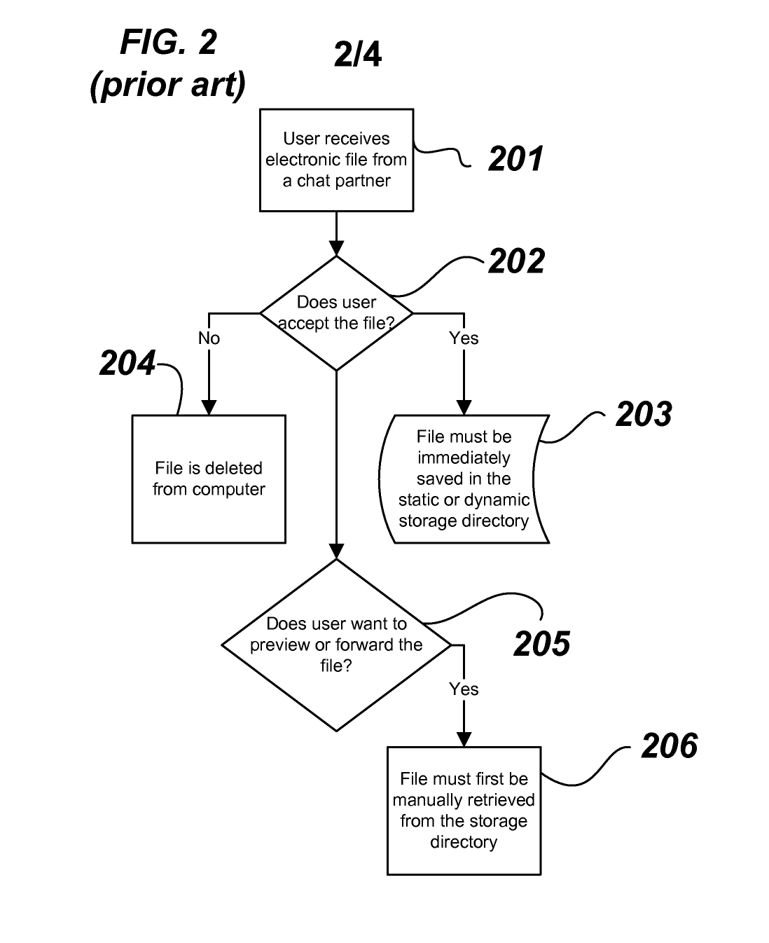

FIG. 2 illustrates a prior art implementation of file transfers. The user receives an electronic file from a chat partner at step 201 and must decide whether to accept the file at step 202. If the user chooses to accept the file, the user must immediately and explicitly save the file in a storage directory selected in static or dynamic fashion at step 203. Otherwise, the file is deleted from the computer at step 204. Thereafter, if the user chooses to preview or forward the file, it must be manually retrieved from the storage directory at step 206. Moreover, if the user desires to delete the file, the user must locate the file in the storage directory and manually delete it.

FIG. 3 illustrates the added functionality of an embodiment of the invention. A chat application associated with the chat service and residing on the user's computer implements new and improved features, wherein as soon as the user receives and accepts an electronic file from a chat partner 101, at step 301, the file is automatically saved in a temporary storage directory at step 302 and the user does not need to be prompted to save the file in a static or dynamic storage directory.

The temporary storage directory could be, for example, “C:\Documents and Settings\Administrator\Local Settings\Temp”. Each temporarily stored file could preferably be identified with a new filename comprised of the original filename and the chat session id and/or time of download. Alternatively, each temporarily stored file could retain the filename associated with that file upon receipt. If the target user wants to preview the file, the temporarily stored copy can be used to display the file 304, to the extent possible, for preview on the7 display 107, at step 305. Additionally, if the user desires to forward the file to another user in the chat service 103, then at step 303 the temporary file can be automatically retrieved from the temporary storage directory at step 304 and forwarded to the intended recipient via communication line 106, at step 305 connected to the chat service.

According to the described embodiment, the user does not need to know the actual filename of the received file or where it is being temporarily stored in order to preview the file or to forward it to another user in the chat service.

Upon exiting the chat service, the associated chat application can prompt the user with the option to permanently save the downloaded file(s) that are currently in the temporary directory at step 306. The user can then chose to save (some of) the downloaded file(s) in the static or dynamic storage directory at step 307, in which case the selected files can be moved or copied into the permanent storage directory. Alternatively, the user can decline to save the downloaded files, in which case the chat application can be preconfigured to automatically delete the downloaded files at step 308. In an alternative embodiment, the chat application can be preconfigured to leave the files in the temporary directory to be deleted the next time all the files in the temporary directory are deleted, which commonly occurs during automatic system “cleanup” processes or by a user-initiated “cleanup” processes that delete the files in temporary directories in order to increase available storage capacity.

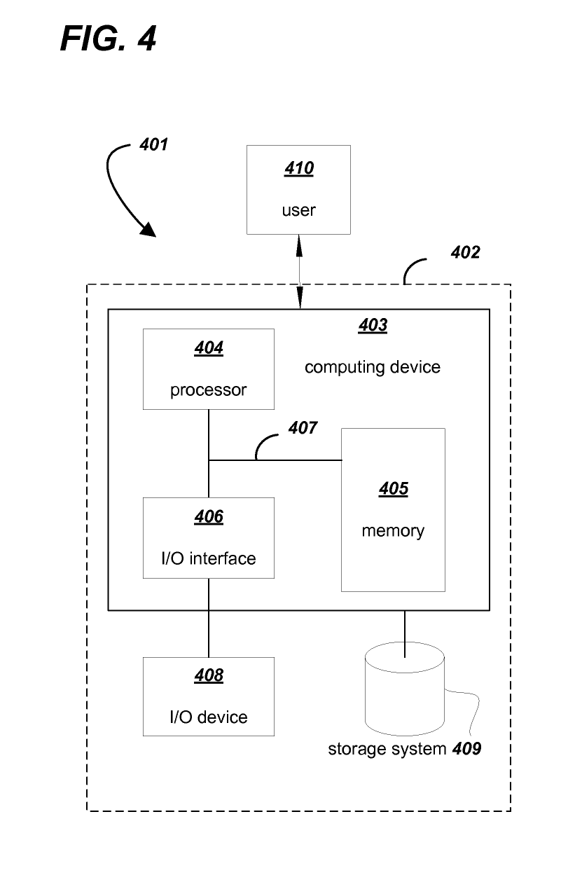

FIG. 4 shows an illustrative environment 401 for managing the processes in accordance with the embodiment of the invention. To this extent, the environment 401 includes a computer infrastructure 402 that can perform the processes described herein. In particular, the computer infrastructure 402 is shown including a computing device 403 operable to perform the processes described herein. The computing device 403 is shown including a processor 404, a memory 405, an input/output (I/O) interface 406, and a bus 407. Further, the computing device 403 is shown in communication with an external I/O device/resource 408 and a storage system 409. As is known in the art, in general, the processor 404 executes computer program code, which is stored in memory 405 and/or storage system 409. While executing computer program code, the processor 404 can read and/or write data to/from memory 405, storage system 409, and/or I/O interface 406. The bus 407 provides a communications link between each of the components in the computing device 403. The I/O device 408 can comprise any device that enables an individual to interact with the computing device 403 or any device that enables the computing device 403 to communicate with one or more other computing devices using any type of communications link.

The computing device 403 can comprise any general purpose computing article of manufacture capable of executing computer program code installed thereon (e.g., a personal computer, server, handheld device, etc.). However, it is understood that the computing device 403 is only representative of various possible equivalent computing devices that may perform the processes described herein. Similarly, the computer infrastructure 402 is only illustrative of various types of computer infrastructures for implementing the invention. For example, in one embodiment, the computer infrastructure 402 comprises two or more computing devices (e.g., a server cluster) that communicate over any type of communications link, such as a network, a shared memory, or the like, to perform the process described herein.

The real-time messaging application in the described embodiment can be executed by computing device 403 wherein the application is stored in memory 405 and/or the storage system 409 and processed by the processor 404. The real-time messaging application can connect to the real-time messaging service on a network via I/O interface 406 which is connected to the I/O device 408. The user 410 can use the real-time messaging application via the I/O device 408 (which is connected to I/O interface 406) to practice the embodiment of the invention.

The advantages of this invention are therefore demonstrated in that the user is not required to save the file to permanent storage in order to preview the file or to forward the file to another user in the chat service. The process of saving of the file to a temporary directory can be entirely managed by the chat application associated with the chat service. Additionally, the chat application can be preconfigured to automatically delete files in the temporary directory that were received by the chat application after the user exits the chat service. This makes file management related to the chat service more autonomic and self controlled than the existing systems.

Additional implementations of this invention can be contemplated in a variety of real-time and non-real-time messaging services. Additionally, benefits and functionality other than the previewing and forwarding of files can be conceived and implemented wherein the user is not required to explicitly save a received electronic file in permanent (static or dynamic) storage directory because the files can be automatically saved to a temporary storage directory.

What is claimed is:

1. A method for previewing or forwarding electronic files received during a chat session, comprising:
receiving an electronic file via a real-time messaging application that is associated with a real-time messaging service,
accepting the received electronic file,
automatically saving the electronic file in a predetermined temporary storage directory,
selectively previewing the electronic file without requiring the electronic file to be saved in a permanent storage directory and without prompting a user of the real-time messaging application for a storage location of the electronic file or a filename of the electronic file,
selectively using the real-time messaging application to forward the electronic file to another user of the real-time messaging service without requiring the electronic file to be saved in a permanent storage directory and without prompting a user of the real-time messaging application for a storage location of the electronic file or a filename of the electronic file, and
deleting the electronic file from the temporary storage directory before terminating the real-time messaging application.
